(19) United States
(12) Patent Application Publication
(10) Pub. No.: US 2020/0196278 A1
(43) Pub. Date: Jun. 18, 2020

(54) AGGREGATING GROUP ADDRESSED FRAMES

(71) Applicant: QUALCOMM Incorporated, San Diego, CA (US)

(72) Inventors: Alfred ASTERJADHI, San Diego, CA (US); Padmanabhan Venkataraman KARTHIC, Chennai (IN); George CHERIAN, San Diego, CA (US); Abhishek Pramod PATIL, San Diego, CA (US); Guido Robert FREDERIKS, Watsonville, CA (US); Renuka Devi NAGARAJAN, Chennai (IN); Arun ANGANAN, Chennai (IN); Sandip HOMCHAUDHURI, San Jose, CA (US)

(21) Appl. No.: 16/601,286

(22) Filed: Oct. 14, 2019

(30) Foreign Application Priority Data
Dec. 17, 2018 (IN) 201841047680

(51) Int. Cl. H04W 72/04; H04W 52/02; H04L 29/12

(52) U.S. Cl. CPC H04W 72/04; H04W 80/02; H04L 61/2069; H04W 52/0235

(57) ABSTRACT

Certain aspects of the present disclosure are directed to an apparatus for wireless communication. The apparatus generally includes a processing system configured to generate a physical layer convergence protocol data unit (PPDU) having an aggregated medium access control (MAC) protocol data unit (A-MPDU), the A-MPDU comprising a plurality of frames, each of the plurality of frames being addressed to a plurality of stations, wherein one or more parameters used for the generation of the A-MPDU or the PPDU depend on one or more capabilities of each of the plurality of stations, and a first interface configured to output the PPDU for transmission.

### CLAIM OF PRIORITY

This application claims priority to Indian Application No. 201841047680, filed Dec. 17, 2018, which is assigned to the assignee hereof and hereby expressly incorporated by reference herein in its entirety as if fully set forth below and for all applicable purposes.

### FIELD

Certain aspects of the present disclosure generally relate to wireless communications and, more particularly, to aggregating frames.

### BACKGROUND

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique for communication systems. MIMO technology has been adopted in several wireless communications standards such as the Institute of Electrical and Electronics Engineers (IEEE) 802.11 standard. The IEEE 802.11 denotes a set of Wireless Local Area Network (WLAN) air interface standards developed by the IEEE 802.11 committee for short-range communications (e.g., tens of meters to a few hundred meters).

### SUMMARY

Certain aspects of the present disclosure are directed to an apparatus for wireless communication. The apparatus generally includes a processing system configured to generate a physical layer convergence protocol data unit (PPDU) having an aggregated medium access control (MAC) protocol data unit (A-MPDU), the A-MPDU including a plurality of frames, each of the plurality of frames being addressed to a plurality of stations, wherein one or more parameters used for the generation of the A-MPDU or the PPDU depend on one or more capabilities of each of the plurality of stations, and a first interface configured to output the PPDU for transmission.

Certain aspects of the present disclosure are directed to an apparatus for wireless communication. The apparatus generally includes a first interface configured to obtain PPDU having an A-MPD), the A-MPDU including a plurality of frames, each of the plurality of frames being addressed to a plurality of stations, where the apparatus is associated with one of the plurality of stations, and wherein one or more parameters associated with the A-MPDU or the PPDU correspond to one or more capabilities of the apparatus, and a processing system configured to decode the A-MPDU.

Certain aspects of the present disclosure are directed to a method for wireless communication. The method generally includes generating a PPDU having an A-MPDU, the A-MPDU including a plurality of frames, each of the plurality of frames being addressed to a plurality of stations, where one or more parameters used for the generation of the A-MPDU or the PPDU depend on one or more capabilities of each of the plurality of stations, and outputting the PPDU for transmission.

Certain aspects of the present disclosure are directed to a method for wireless communication. The method generally includes obtaining, at an apparatus, a PPDU having an A-MPDU, the A-MPDU including a plurality of frames, each of the plurality of frames being addressed to a plurality of stations, where the apparatus is associated with one of the plurality of stations, and where one or more parameters associated with the A-MPDU or the PPDU correspond to one or more capabilities of the apparatus, and decoding the PPDU.

Certain aspects of the present disclosure are directed to an apparatus for wireless communication. The apparatus generally includes means for generating a PPDU having an A-MPDU, the A-MPDU including a plurality of frames, each of the plurality of frames being addressed to a plurality of stations, where one or more parameters used for the generation of the A-MPDU or the PPDU depend on one or more capabilities of each of the plurality of stations, and means for outputting the PPDU for transmission.

Certain aspects of the present disclosure are directed to an apparatus for wireless communication. The apparatus generally includes means for obtaining a PPDU having an A-MPDU, the A-MPDU including a plurality of frames, each of the plurality of frames being addressed to a plurality of stations, where the apparatus is associated with one of the plurality of stations, and, where one or more parameters associated with the A-MPDU or the PPDU correspond to one or more capabilities of the apparatus, and means for decoding the PPDU.

Certain aspects of the present disclosure are directed to an apparatus for wireless communication. The apparatus generally includes at least one antenna, a processing system configured to generate a PPDU having an A-MPDU, the A-MPDU including a plurality of frames, each of the plurality of frames being addressed to a plurality of stations, where one or more parameters used for the generation of the A-MPDU or the PPDU depend on one or more capabilities of each of the plurality of stations, and a first interface configured to output the PPDU for transmission via the at least one antenna.

Certain aspects of the present disclosure are directed to an apparatus for wireless communication. The apparatus generally includes at least one antenna, a first interface configured to obtain, via the at least one antenna, a PPDU having an A-MPDU, the A-MPDU including a plurality of frames, each of the plurality of frames being addressed to a plurality of stations, where the apparatus is associated with one of the plurality of stations, and, where one or more parameters associated with the A-MPDU or the PPDU correspond to one or more capabilities of the apparatus, and a processing system configured to decode the PPDU.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a diagram of an example wireless communications network, in accordance with certain aspects of the present disclosure.

FIG. 2 is a block diagram of an example access point and example stations, in accordance with certain aspects of the present disclosure.

FIG. 3 illustrates an example wireless device, in accordance with certain aspects of the present disclosure.

FIG. 4 is a flow diagram illustrating example operations by an access point (AP), in accordance with certain aspects of the present disclosure.

FIG. 5 is a flow diagram illustrating example operations by a station, in accordance with certain aspects of the present disclosure.

FIG. 6 is a call flow diagram illustrating example operations for communicating group addressed frames, in accordance with certain aspects of the present disclosure.

FIGS. 7 and 8 illustrate communications devices that may include various components configured to perform operations for the techniques disclosed herein.

### DETAILED DESCRIPTION

Certain aspects of the present disclosure provide apparatus and techniques that allow aggregation of group addressed frames and define rules that allow stations of different capabilities to be able to receive these frames. In other words, an access point (AP) or a station (STA) may generate a group addressed frame in accordance with capabilities of stations to which the frame is addressed. For instance, an AP or a STA may aggregate group addressed data units in an aggregated data unit provided that the aggregated data unit satisfies the requirements of the lowest performing station.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, system or network that is capable of transmitting and receiving RF signals according to any of the IEEE 16.11 standards, or any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing 3G, 4G or 5G, or further implementations thereof, technology.

The techniques described herein may be used for various broadband wireless communication systems, including communication systems that are based on a single carrier transmission. Aspects may be, for example, advantageous to systems employing Ultra-Wide Band (UWB) signals including millimeter-wave signals. However, this disclosure is not intended to be limited to such systems, as other coded signals may benefit from similar advantages.

The techniques may be incorporated into (such as implemented within or performed by) a variety of wired or wireless apparatuses (such as nodes). In some implementations, a node includes a wireless node. Such a wireless node may provide, for example, connectivity to or for a network (such as a wide area network (WAN) such as the Internet or a cellular network) via a wired or wireless communication link. In some implementations, a wireless node may include an access point or a station.

The techniques described herein may be used for various broadband wireless communication systems, including communication systems that are based on an orthogonal multiplexing scheme. Examples of such communication systems include Spatial Division Multiple Access (SDMA), Time Division Multiple Access (TDMA), Orthogonal Frequency Division Multiple Access (OFDMA) systems, Single-Carrier Frequency Division Multiple Access (SC-FDMA) systems, and so forth. An SDMA system may utilize sufficiently different directions to simultaneously transmit data belonging to multiple stations. A TDMA system may allow multiple stations to share the same frequency channel by dividing the transmission signal into different time slots, each time slot being assigned to different stations. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The teachings herein may be incorporated into (e.g., implemented within or performed by) a variety of wired or wireless apparatuses (e.g., nodes). In some aspects, a wireless node implemented in accordance with the teachings herein may include an access point or an access terminal.

An access point (“AP”) may include, be implemented as, or known as a Node B, a Radio Network Controller (“RNC”), an evolved Node B (eNB), a Base Station Controller (“BSC”), a Base Transceiver Station (“BTS”), a Base Station (“BS”), a Transceiver Function (“TF”), a Radio Router, a Radio Transceiver, a Basic Service Set (“BSS”), an Extended Service Set (“ES S”), a Radio Base Station (“RBS”), or some other terminology.

An access terminal (“AT”) may include, be implemented as, or known as a subscriber station, a subscriber unit, a mobile station, a remote station, a remote terminal, a station, a user agent, a user device, user equipment, a user station, or some other terminology. In some implementations, an access terminal may include a cellular telephone, a cordless telephone, a Session Initiation Protocol (“SIP”) phone, a wireless local loop (“WLL”) station, a personal digital assistant (“PDA”), a handheld device having wireless connection capability, a Station (“STA”), or some other suitable processing device connected to a wireless modem. Accordingly, one or more aspects taught herein may be incorporated into a phone (e.g., a cellular phone or smart phone), a computer (e.g., a laptop), a portable communication device, a portable computing device (e.g., a personal data assistant), an entertainment device (e.g., a music or video device, or a satellite radio), a global positioning system device, or any other suitable device that is configured to communicate via a wireless or wired medium. In some aspects, the node is a wireless node. Such wireless node may provide, for example, connectivity for or to a network (e.g., a wide area network such as the Internet or a cellular network) via a wired or wireless communication link.

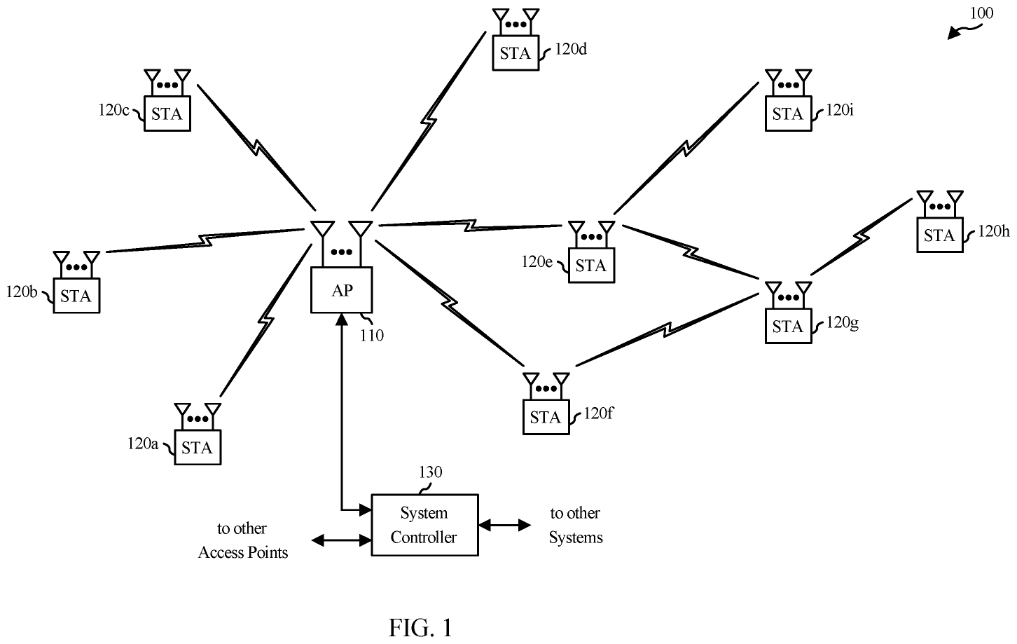

FIG. 1 illustrates a system 100 in which aspects of the disclosure may be performed. The system 100 may be, for example, a multiple-access multiple-input multiple-output (MIMO) system 100 with access points and stations. For simplicity, only one access point 110 is shown in FIG. 1. An access point is generally a fixed station that communicates with the stations and may also be referred to as a base station or some other terminology. A STA may be fixed or mobile and may also be referred to as a mobile station, a wireless device, or some other terminology. Access point 110 may communicate with one or more stations 120 at any given moment on the downlink and uplink. The downlink (i.e., forward link) is the communication link from the access point to the stations, and the uplink (i.e., reverse link) is the communication link from the stations to the access point. A station may also communicate peer-to-peer with another station.

A system controller 130 may provide coordination and control for these APs or other systems. The APs may be managed by the system controller 130, for example, which may handle adjustments to radio frequency power, channels, authentication, and security. The system controller 130 may communicate with the APs via a backhaul. The APs may also communicate with one another, e.g., directly or indirectly via a wireless or wireline backhaul.

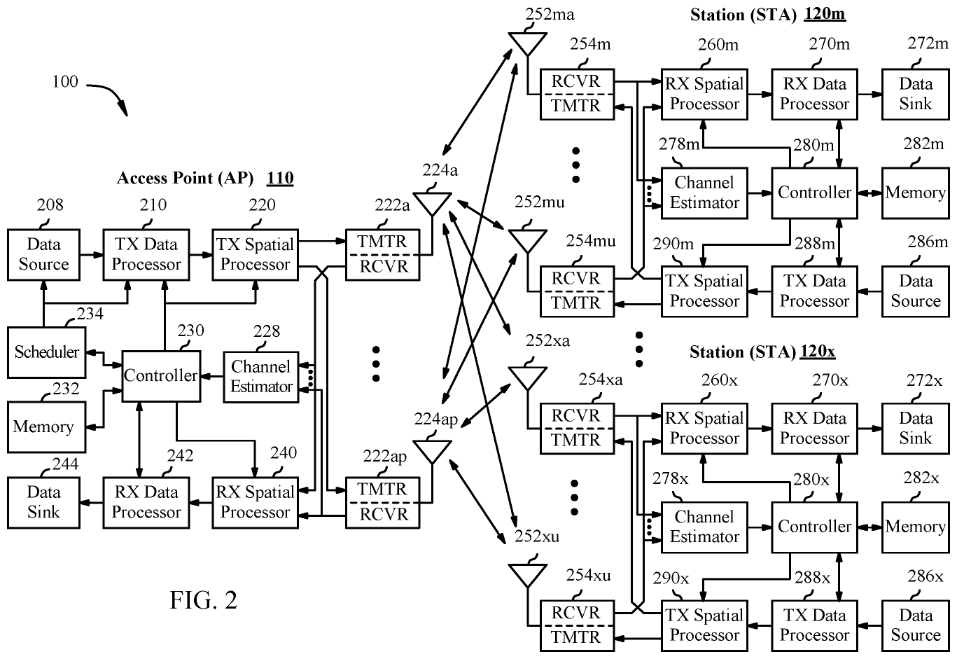

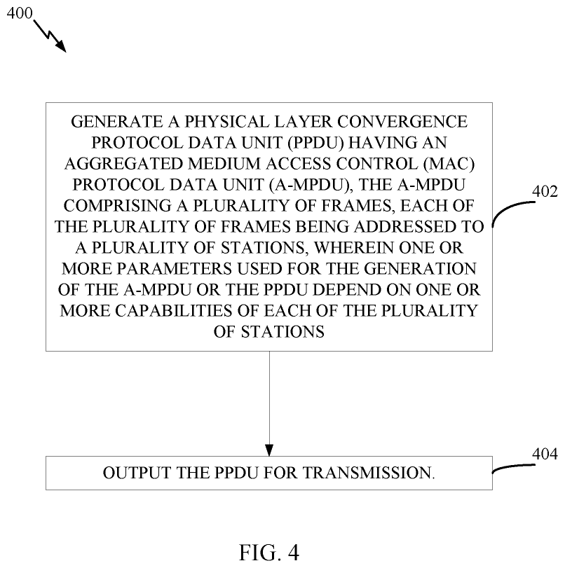

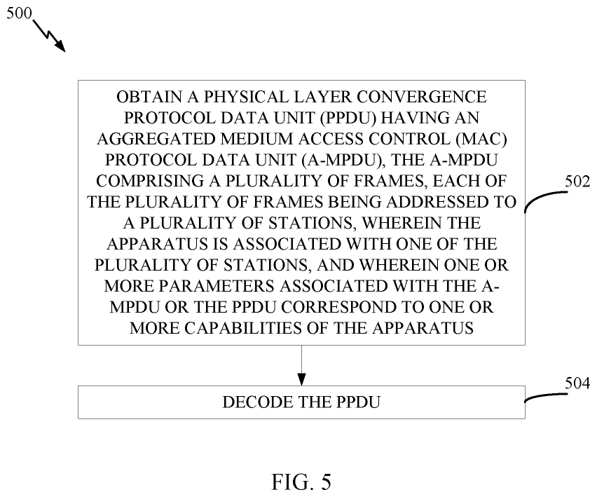

FIG. 2 illustrates example components of the access point 110 and station 120 illustrated in FIG. 1, which may be used to implement aspects of the present disclosure. One or more components of the access point 110 and station 120 may be used to practice aspects of the present disclosure. For example, antenna 224, transmitter/receiver unit 222, processors 210, 220, 240, 242, controller 230, antenna 252, transmitter/receiver 254, processors 260, 270, 288, and 290, or controller 280, or any combination thereof, may be used to perform the operations described herein and illustrated with reference to FIGS. 4-5.

FIG. 2 illustrates a block diagram of access point 110 two stations 120m and 120x in a MIMO system 100. The access point 110 is equipped with Nₜ antennas 224a through 224ap. STA 120m is equipped with N_{ut,m} antennas 252ma through 252mu, and STA 120x is equipped with N_{ut,x} antennas 252xa through 252xu. The access point 110 is a transmitting entity for the downlink and a receiving entity for the uplink. Each station 120 is a transmitting entity for the uplink and a receiving entity for the downlink. As used herein, a “transmitting entity” is an independently operated apparatus or device capable of transmitting data via a wireless channel, and a “receiving entity” is an independently operated apparatus or device capable of receiving data via a wireless channel. In the following description, the subscript “dn” denotes the downlink, the subscript “up” denotes the uplink, Nup STA are selected for simultaneous transmission on the uplink, Ndn stations are selected for simultaneous transmission on the downlink, Nup may or may not be equal to Ndn, and Nup and Ndn may be static values or can change for each scheduling interval. The beam-steering or some other spatial processing technique may be used at the access point and station.

On the uplink, at each station 120 selected for uplink transmission, a transmit (TX) data processor 288 receives traffic data from a data source 286 and control data from a controller 280. The controller 280 may be coupled with a memory 282. TX data processor 288 processes (e.g., encodes, interleaves, and modulates) the traffic data for the STA based on the coding and modulation schemes associated with the rate selected for the STA and provides a data symbol stream. A TX spatial processor 290 performs spatial processing on the data symbol stream and provides N_{ut,m} transmit symbol streams for the N_{ut,m} antennas. Each transmitter unit (TMTR) 254 receives and processes (e.g., converts to analog, amplifies, filters, and frequency upconverts) a respective transmit symbol stream to generate an uplink signal. N_{ut,m} transmitter units 254 provide N_{ut,m} uplink signals for transmission from N_{ut,m} antennas 252 to the access point.

Nup stations may be scheduled for simultaneous transmission on the uplink. Each of these stations performs spatial processing on its data symbol stream and transmits its set of transmit symbol streams on the uplink to the access point.

At access point 110, Nₐₚ antennas 224a through 224ap receive the uplink signals from all Nup stations transmitting on the uplink. Each antenna 224 provides a received signal to a respective receiver unit (RCVR) 222. Each receiver unit 222 performs processing complementary to that performed by transmitter unit 254 and provides a received symbol stream. An RX spatial processor 240 performs receiver spatial processing on the Nₐₚ received symbol streams from Nₐₚ receiver units 222 and provides Nup recovered uplink data symbol streams. The receiver spatial processing is performed in accordance with the channel correlation matrix inversion (CCMI), minimum mean square error (MMSE), soft interference cancellation (SIC), or some other technique. Each recovered uplink data symbol stream is an estimate of a data symbol stream transmitted by a respective STA. An RX data processor 242 processes (e.g., demodulates, deinterleaves, and decodes) each recovered uplink data symbol stream in accordance with the rate used for that stream to obtain decoded data. The decoded data for each STA may be provided to a data sink 244 for storage and in some cases, to a controller 230 for further processing. The controller 230 may be coupled with a memory 232.

On the downlink, at access point 110, a TX data processor 210 receives traffic data from a data source 208 for Ndn stations scheduled for downlink transmission, control data from a controller 230, and possibly other data from a scheduler 234. The various types of data may be sent on different transport channels. TX data processor 210 processes (e.g., encodes, interleaves, and modulates) the traffic data for each STA based on the rate selected for that STA. TX data processor 210 provides Ndn downlink data symbol streams for the Ndn stations. A TX spatial processor 220 performs spatial processing (such as a precoding or beamforming, as described in the present disclosure) on the Ndn downlink data symbol streams, and provides Nₐₚ transmit symbol streams for the Nₐₚ antennas. Each transmitter unit 222 receives and processes a respective transmit symbol stream to generate a downlink signal. Nₐₚ transmitter units 222 providing Nₐₚ downlink signals for transmission from Nₐₚ antennas 224 to the stations. The decoded data for each STA may be provided to a data sink 272 for storage and in some cases, a controller 280 for further processing.

At each station 120, N_{ut,m} antennas 252 receive the Nₐₚ downlink signals from access point 110. Each receiver unit 254 processes a received signal from an associated antenna 252 and provides a received symbol stream. An RX spatial processor 260 performs receiver spatial processing on N_{ut,m} received symbol streams from N_{ut,m} receiver units 254 and provides a recovered downlink data symbol stream for the STA. The receiver spatial processing is performed in accordance with the CCMI, MMSE or some other technique. An RX data processor 270 processes (e.g., demodulates, deinterleaves and decodes) the recovered downlink data symbol stream to obtain decoded data for the station.

At each station 120, a channel estimator 278 estimates the downlink channel response and provides downlink channel estimates, which may include channel gain estimates, signal-to-noise ratio (SNR) estimates, noise variance and so on. Similarly, at access point 110, a channel estimator 228 estimates the uplink channel response and provides uplink channel estimates. Controller 280 for each STA typically derives the spatial filter matrix for the STA based on the downlink channel response matrix Hdn,m for that STA. Controller 230 derives the spatial filter matrix for the access point based on the effective uplink channel response matrix Hup,eff. Controller 280 for each STA may send feedback information (e.g., the downlink or uplink eigenvectors, eigenvalues, SNR estimates, and so on) to the access point. Controllers 230 and 280 also control the operation of various processing units at access point 110 and station 120, respectively.

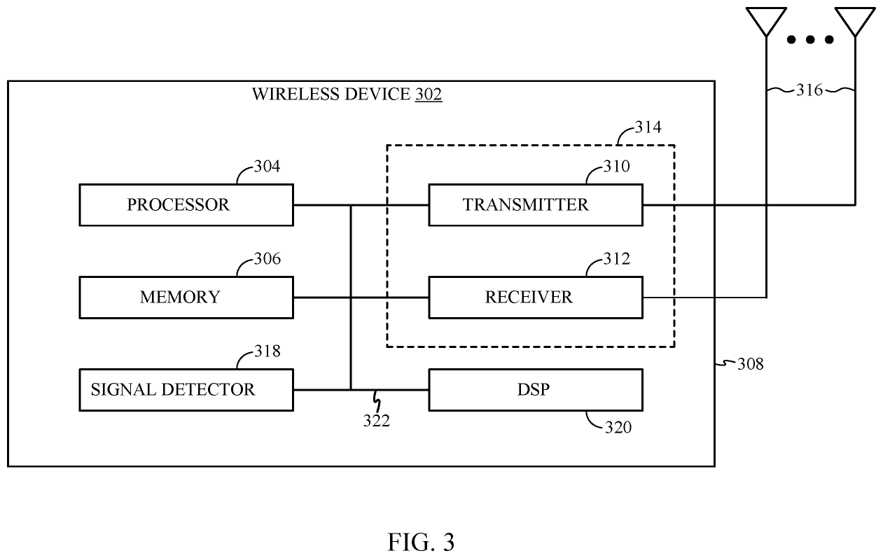

FIG. 3 illustrates various components that may be utilized in a wireless device 302 that may be employed within the MIMO system 100. The wireless device 302 is an example of a device that may be configured to implement the various methods described herein. For example, the wireless device may implement operations 400 and 500. The wireless device 302 may be an access point 110 or a station 120.

The wireless device 302 may include a processor 304 which controls operation of the wireless device 302. The processor 304 may also be referred to as a central processing unit (CPU). Memory 306, which may include both read-only memory (ROM) and random access memory (RAM), provides instructions and data to the processor 304. A portion of the memory 306 may also include non-volatile random access memory (NVRAM). The processor 304 typically performs logical and arithmetic operations based on program instructions stored within the memory 306. The instructions in the memory 306 may be executable to implement the methods described herein.

The wireless device 302 may also include a housing 308 that may include a transmitter 310 and a receiver 312 to allow transmission and reception of data between the wireless device 302 and a remote node. The transmitter 310 and receiver 312 may be combined into a transceiver 314. A single or a plurality of transmit antennas 316 may be attached to the housing 308 and electrically coupled to the transceiver 314. The wireless device 302 may also include (not shown) multiple transmitters, multiple receivers, and multiple transceivers.

The wireless device 302 may also include a signal detector 318 that may be used in an effort to detect and quantify the level of signals received by the transceiver 314. The signal detector 318 may detect such signals as total energy, energy per subcarrier per symbol, power spectral density and other signals. The wireless device 302 may also include a digital signal processor (DSP) 320 for use in processing signals.

The various components of the wireless device 302 may be coupled together by a bus system 322, which may include a power bus, a control signal bus, and a status signal bus in addition to a data bus.

Currently, group addressed frames for the IEEE 802.11 standard are sent as a single medium access control (MAC) protocol data unit (MPDU) carried in a single physical layer convergence protocol data unit (PPDU), which is not efficient. One reason wireless devices use single PPDUs to send group addressed frames is to accommodate legacy devices which may not support aggregation of more than one frame (e.g., MPDU) in the same PPDU.

In certain bands, or in cases where a wireless device plans to only support stations that support aggregation, it is possible to efficiently deliver group addressed frames to the stations in an aggregated medium access control (MAC) protocol data unit (A-MPDU). However, stations may have some processing delays and limitations, and therefore, A-MPDU aggregation of group addressed frames may follow certain rules that account for the limitations declared by all stations that are the addressed receivers of these frames. Certain aspects of the present disclosure allow aggregation of group addressed frames in an A-MPDU and define rules that allow stations of different capabilities to be able to receive these frames.

FIG. 4 is a flow diagram illustrating example operations 400 for wireless communication, in accordance with certain aspects of the present disclosure. The operations 400 may be performed by an apparatus (e.g., wireless device) such as an access point (AP) (e.g., AP 110) or a station (e.g., station 120).

Operations 400 may be implemented as software components that are executed and run on one or more processors (e.g., controller 230 or controller 280 of FIG. 2). Further, the transmission and reception of signals by the AP or station in operations 400 may be enabled, for example, by one or more antennas (e.g., antennas 224 or antennas 252 of FIG. 2). In certain aspects, the transmission or reception of signals by the AP or the STA may be implemented via a bus interface of one or more processors (e.g., controller 230 or controller 280 of FIG. 2) obtaining or outputting signals.

The operations 400 begin, at block 402, by generating a PPDU having an A-MPDU, the A-MPDU including a plurality of frames, each of the plurality of frames being addressed to a plurality of stations. For example, each of the plurality of frames may be transmitted (e.g., broadcast) to a plurality of stations. In certain aspects, one or more parameters used for the generation of the A-MPDU or the PPDU depend on one or more capabilities of each of the plurality of stations. In certain aspects, the one or more parameters may correspond to a configuration of the A-MPDU. For instance, the one or more parameters may include a minimum spacing between the plurality of frames of the A-MPDU, a maximum length of the A-MPDU, a maximum number of the plurality of frames of the A-MPDU, or a maximum receive rate (e.g., data rate), as will be described in more detail herein. At block 404, the PPDU may be output for transmission.

FIG. 5 is a flow diagram illustrating example operations 500 for wireless communication, in accordance with certain aspects of the present disclosure. The operations 500 may be performed by an apparatus such as a station (e.g., station 120) or an AP (e.g. AP 110).

Operations 500 may be implemented as software components that are executed and run on one or more processors (e.g., controller 280 or controller 230 of FIG. 2). Further, the transmission (e.g., outputting for transmission) and reception (obtaining) of signals by the station or the AP in operations 500 may be enabled, for example, by one or more antennas (e.g., antennas 252 or antennas 224 of FIG. 2). In certain aspects, the transmission (e.g., outputting for transmission) or reception (obtaining) of signals by the station or AP may be implemented via a bus interface of one or more processors (e.g., controller 280 or controller 230 of FIG. 2) obtaining or outputting signals.

The operations 500 begin, at block 502, by obtaining a PPDU having an A-MPDU, the A-MPDU including a plurality of frames, each of the plurality of frames being addressed to a plurality of stations, and at block 504, decoding the A-MPDU. For example, each of the plurality of frames may be transmitted (e.g., broadcast) to a plurality of stations. As described herein, the operations 500 may be performed by an apparatus. The apparatus may be associated with (e.g., hosted by) one of the plurality of stations. In certain aspects, one or more parameters associated with the A-MPDU or the PPDU correspond to one or more capabilities of the station. For example, the apparatus (e.g., station 120) may output an indication of a capability of the apparatus associated with the one or more parameters (e.g., a configuration of the A-MPDU). In other words, the apparatus may indicate a supported minimum spacing between the plurality of frames of the A-MPDU, a maximum length of the A-MPDU, a maximum number of the plurality of frames of the A-MPDU, or a maximum receive rate, based on which the A-MPDU or PPDU may be generated by the wireless device and transmitted to another wireless device, as described in more detail herein.

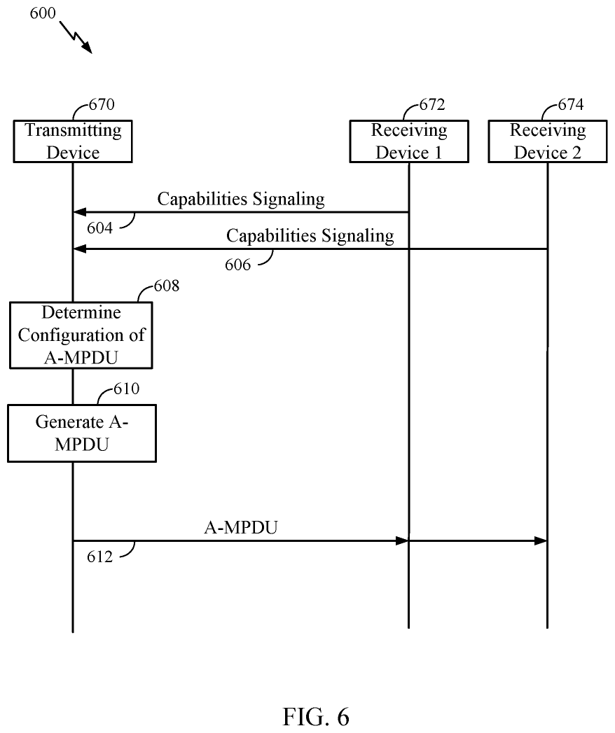

FIG. 6 is a call flow diagram illustrating example operations 600 for communicating group addressed frames, in accordance with certain aspects of the present disclosure. As illustrated, multiple receiving devices 672, 674 (e.g., stations) may be associated with a transmitting device 670 (e.g., AP) and may send capabilities signaling 604, 606 to the transmitting device 670. In other words, every receiving device that is associated with a transmitting device (e.g., AP) may declare one or more of the following capabilities corresponding to the one or more parameters used for the generation of the PPDU or A-MPDU. For example, the receiving devices may indicate a capability with respect to a minimum MPDU start spacing, which is the amount of time the receiving device may require in reception (e.g., in microseconds) between subsequent MPDUs in the same A-MPDU. For example, the receiving devices may indicate a value of 0 indicating that the receiving device has no restriction with respect to the minimum MPDU start spacing, may indicate 1 for ¼ μs minimum MPDU start spacing, may indicate 2 for ½ μs minimum MPDU start spacing, may indicate 3 for 1 μs minimum MPDU start spacing, may indicate 4 for 2 μs minimum MPDU start spacing, may indicate 5 for 4 μs minimum MPDU start spacing, etc.

In some cases, each receiving device may indicate a capability with respect to a maximum A-MPDU length exponent, which provides the maximum A-MPDU length (e.g., in octets) that the receiving device can receive in a PPDU. For example, the indicated maximum A-MPDU length exponent may be used in the following equation to indicate the number of octets for the A-MPDU length (in octets), where the maximum A-MPDU length exponent is any nonnegative integer.

2^{13+maximum A-MPDU Length Exponent}−1

In some cases, the receiving device may indicate a capability with respect to maximum number of MPDUs in an A-MPDU, which provides the maximum number of MPDUs that the receiving device can receive in an A-MPDU. For example, a receiving device may indicate a value of 1 for 1 MPDU, a value of 2 for 4 MPDUs, a value of 3 for 8 MPDU, a value of 4 for 16 MPDUs, and so on.

The transmitting device 670 may then determine the configuration of the A-MPDU based on the capabilities signaling from the receiving devices 672, 674 at block 608, and generate the A-MPDU accordingly at block 610. The A-MPDU may then be transmitted to the receiving devices 672, 674. In certain aspects, the transmitting device 670 may send the group addressed A-MPDU 612 with different rates (e.g., data rates) depending on operating modes of the receiving devices that are associated with the transmitting device 670. For example, the group addressed A-MPDU may be sent using a first rate that is up to the highest rate (e.g., highest data rate) that is supported by the receiving devices 672, 674 that are associated with the transmitting device 670 and to which the A-MPDU is addressed, when all the receiving devices are in a first operating mode. The transmitting device may send the group addressed A-MPDU with a second rate that is up to the highest rate that is supported by the receiving devices 672, 674 that are associated with the transmitting device 670 and to which the A-MPDU is addressed to, when at least one of the receiving devices 672, 674 is in a second operating mode. In certain aspects, the first and second operating modes may correspond to different power management (PM) modes (also referred to as PM states) of the stations, as will described in more detail herein.

In certain aspects, the type of group addressed frames that can be aggregated in the A-MPDU may be restricted. For example only data frames may be aggregated, or only management frames may be aggregated, or both. For instance, the receiving devices 672, 674 may indicate to the transmitting device 670 whether they support aggregation of data frame, management frames, or both data and management frames, based on which the transmitting device 670 may generate A-MPDUs accordingly.

In certain aspects, a receiving device may indicate a capability with respect to a maximum value of a receive parameter (e.g., modulation and coding scheme (MCS)) that the receiving device can receive the group addressed A-MPDU. The maximum receive parameter may directly or indirectly impact either the rate at which the receiving device is capable of receiving information or the amount of energy the receiving device consumes at the receiving device for receiving the information. For example, the receive parameter may be at least one or more of a MCS, spatial stream (SS), bandwidth (BW) guard interval (GI), coding (e.g., low-density parity-check (LDPC), space time block coding (STBC), binary convolution code (BCC)), PPDU duration, or amount of padding (e.g., intra-A-MPDU padding, end of frame padding, packet extension). These parameters may be used by the transmitting device to determine the rate at which the frames carried in the A-MPDU 612 of the PPDU are transmitted by the transmitting device (e.g., AP) and received by the receiving devices 672, 674 to which the A-MPDU is addressed to.

In certain aspects, the receiving devices 672, 674 may indicate separate capabilities for one or more of the capabilities described herein corresponding to different operating modes that the receiving device may operate in. For example, each receiving device may indicate a first set of capabilities associated with a first operating mode of the receiving device, and a second set of capabilities associated with a second operating mode of the receiving device. Receiving devices that operate in the first operating mode may consume more energy or be capable of processing information at higher rates compared to the second operating mode, thereby the different operating modes may correspond to different capabilities at the receiving device. For example, the first operating mode may correspond to an active mode (e.g., awake state) and the second operating mode may correspond to a power save mode (e.g., doze state). A receiving device is in an awake state when the receiver front-end circuitry of the receiving device is on. In certain aspects, each receiving device may have the same capabilities for receiving individually addressed A-MPDUs and group addressed A-MPDUs when operating in the first operating mode (e.g., in active mode). A receiving device operating in the active mode (e.g., first operation mode) may always be in an awake state while in active mode. A receiving device operating in the power save mode (e.g., second operating mode) may be either in the awake state or in a doze state. While in power save mode, a receiving device may declare to the transmitting device that the receiving device is in the awake state by sending a power-save (PS) poll or an automatic power save delivery (APSD) trigger frame to the transmitting device. The transmitting device may use the same parameters for generating a group addressed A-MPDU to be sent to receiving devices that have declared to be in the awake state.

If a group addressed frame is intended only for receiving devices associated with an transmitting device, then the transmitting device may set the one or more parameters corresponding to the configuration of the group addressed frame to values that are indicated as supported by all the receiving devices. In certain aspects, if at least one of the receiving devices is currently not in the awake state (e.g., in doze state), the bandwidth of the group addressed frame may be set to 20 MHz.

In certain aspects, one or more of the receiving device capabilities may be associated with the operating mode of the receiving device. For example, each receiving device may dynamically switch between different values of a capability parameter. For instance, a receiving device may switch from being able to process a PPDU with a 20 MHz bandwidth (BW) to being able to process a PPDU with 80 MHz BW. This dynamic switching of an operating mode may be dynamically indicated to the transmitting device (e.g., AP 110), allowing the transmitting device to generate an A-MPDU based on appropriate parameters for the associated receiving devices, as described in more detail herein.

In certain aspects, the one or more receiving device capabilities (e.g., capabilities of receiving devices 672, 674) may be tied to the type of receiving device. For example, if a receiving device is a high efficiency (HE) station, then the station may support, by default, a first value of a certain capability, and if the station is an extremely HE station, or extremely high throughput (EHT) station, then the station may support, by default, a second value of a certain capability. The second value may indicate that the second receiving device is more capable than the first receiving device. Thus, by knowing the type of receiving device, the transmitting device (e.g., AP 110) may assume default capabilities of the associated receiving devices based on a type of each of the receiving devices (e.g., without receiving express capabilities signaling from the receiving devices).

In certain aspects, the transmitting device (e.g., AP 110) may aggregate group addressed MPDUs in an A-MPDU provided that the A-MPDU satisfies the requirements of the lowest performing receiving device (e.g., lowest capability) that is associated with the transmitting device. For example, if 10 receiving devices support 16 MPDUs to be aggregated in an A-MPDU and one receiving device only supports 4 MPDUs to be aggregated in an A-MPDU, the AP may generate an A-MPDU aggregating only 4 MPDUs to accommodate the receiving device having the lowest capability (can only support 4 MPDUs). Similar considerations may be made for other parameters (e.g., capabilities, operating modes, etc.) such as the minimum MPDU start spacing and maximum A-MPDU length exponent.

In certain aspects, the transmitting device (e.g., AP 110) may have different rules for the generation of the A-MPDU depending on the power management (PM) state of the receiving devices. For example, the AP 110 may transmit group addressed frames in an MPDU (e.g., rather than an A-MPDU) if at least one associated receiving devices is in power save mode, and the AP may transmit the group addressed frames in an A-MPDU if all the associated receiving devices are in active mode.

As described herein, receiving devices may dynamically change the above parameters by providing updated capabilities information in frames they transmit to the transmitting device, which may translate to a receiving device dynamically switching between different operating modes. For example, the updated capabilities information may be sent in a MAC header of frames, in information elements (IEs) carried in management frames, etc.

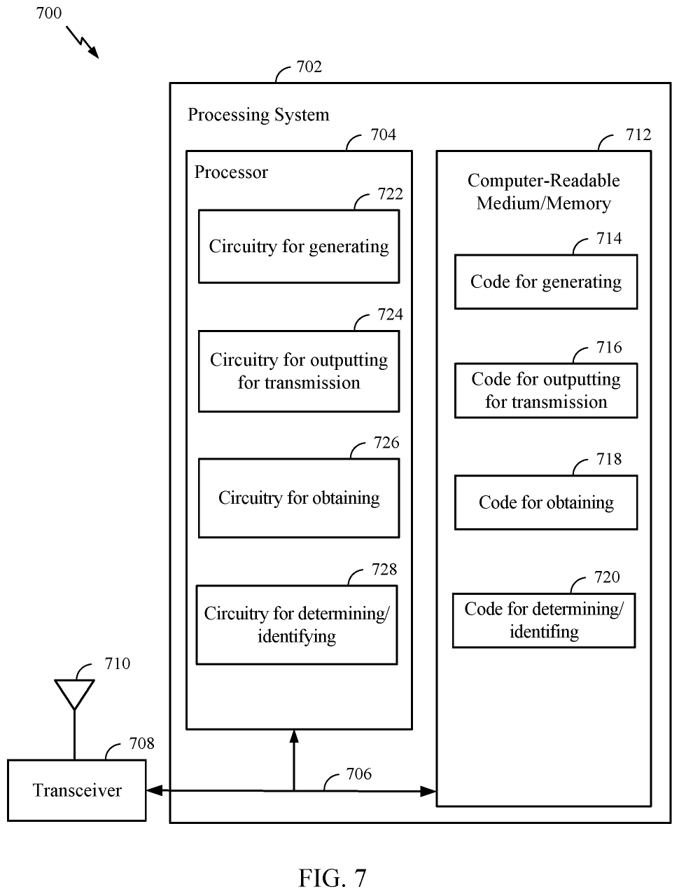

FIG. 7 illustrates a communications device 700 that may include various components (e.g., corresponding to means-plus-function components) configured to perform operations for the techniques disclosed herein, such as the operations illustrated in FIG. 4. The communications device 700 includes a processing system 702 coupled to a transceiver 708. The transceiver 708 is configured to transmit and receive signals for the communications device 700 via an antenna 710, such as the various signals as described herein. The processing system 702 may be configured to perform processing functions for the communications device 700, including processing signals received or to be transmitted by the communications device 700.

The processing system 702 includes a processor 704 coupled to a computer-readable medium/memory 712 via a bus 706. In certain aspects, the computer-readable medium/memory 712 is configured to store instructions (e.g., computer-executable code) that when executed by the processor 704, cause the processor 704 to perform the operations illustrated in FIG. 4, or other operations for performing the various techniques discussed herein for communication of groups addressed frames. In certain aspects, computer-readable medium/memory 712 stores code 714 for generating; code 716 for outputting for transmission; code 718 for obtaining; and code 720 for determining/identifying. In certain aspects, the processor 704 has circuitry configured to implement the code stored in the computer-readable medium/memory 712. The processor 704 includes circuitry 722 for generating; circuitry 724 for outputting for transmission; code 726 for obtaining; and circuitry 728 for determining/identifying.

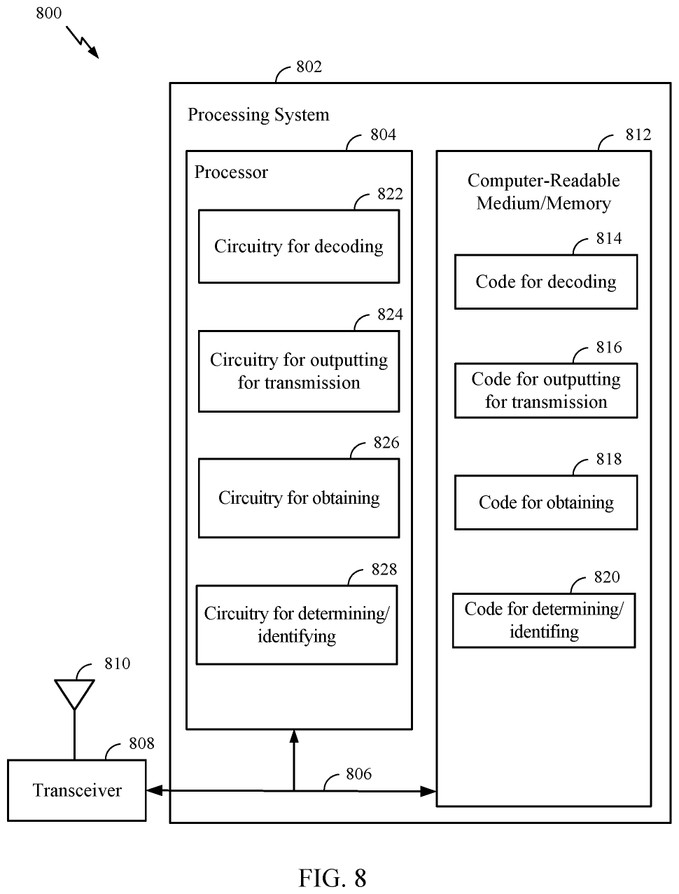

FIG. 8 illustrates a communications device 800 that may include various components (e.g., corresponding to means-plus-function components) configured to perform operations for the techniques disclosed herein, such as the operations illustrated in FIG. 5. The communications device 800 includes a processing system 802 coupled to a transceiver 808. The transceiver 808 is configured to transmit and receive signals for the communications device 800 via an antenna 810, such as the various signals as described herein. The processing system 802 may be configured to perform processing functions for the communications device 800, including processing signals received or to be transmitted by the communications device 800.

The processing system 802 includes a processor 804 coupled to a computer-readable medium/memory 812 via a bus 806. In certain aspects, the computer-readable medium/memory 812 is configured to store instructions (e.g., computer-executable code) that when executed by the processor 804, cause the processor 804 to perform the operations illustrated in FIG. 5, or other operations for performing the various techniques discussed herein for communication of groups addressed frames. In certain aspects, computer-readable medium/memory 812 stores code 814 for generating; code 816 for outputting for transmission; code 818 for obtaining; and code 820 for determining/identifying. In certain aspects, the processor 804 has circuitry configured to implement the code stored in the computer-readable medium/memory 812. The processor 804 includes circuitry 822 for generating; circuitry 824 for outputting for transmission; code 826 for obtaining; and circuitry 828 for determining/identifying.

The various operations of methods described above may be performed by any suitable means capable of performing the corresponding functions. The means may include various hardware or software component(s) or module(s), including, but not limited to a circuit, an application specific integrated circuit (ASIC), or processor. Generally, where there are operations illustrated in figures, those operations may have corresponding counterpart means-plus-function components with similar numbering.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception. In some cases, the interface to output a frame for transmission and the interface to obtain a frame (which may be referred to as first and second interfaces herein) may be the same interface.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of” a list of items refers to any combination of those items, including single members. As an example, “at least one of: a, b, or c” is intended to cover a, b, c, a-b, a-c, b-c, and a-b-c, as well as combinations that include multiples of one or more members (aa, bb, or cc, or any combination thereof).

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may include a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein include one or more steps or actions for achieving the described method. The method steps or actions may be interchanged with one another without departing from the scope of the claims. In other words, unless a specific order of steps or actions is specified, the order or use of specific steps or actions may be modified without departing from the scope of the claims.

The functions described may be implemented in hardware, software, firmware, or any combination thereof. If implemented in hardware, an example hardware configuration may include a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a station 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product. The computer-program product may include packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, or a computer product separate from the wireless node, all which may be accessed by the processor through the bus interface. Alternatively, or in addition, the machine-readable media, or any portion thereof, may be integrated into the processor, such as the case may be with cache or general register files.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may be implemented with an ASIC (Application Specific Integrated Circuit) with the processor, the bus interface, the user interface in the case of an access terminal), supporting circuitry, and at least a portion of the machine-readable media integrated into a single chip, or with one or more FPGAs (Field Programmable Gate Arrays), PLDs (Programmable Logic Devices), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may include a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may include non-transitory computer-readable media (e.g., tangible media). In addition, for other aspects computer-readable media may include transitory computer-readable media (e.g., a signal). Combinations of the above should also be included within the scope of computer-readable media.

Thus, certain aspects may include a computer program product for performing the operations presented herein. For example, such a computer program product may include a computer-readable medium having instructions stored (or encoded) thereon, the instructions being executable by one or more processors to perform the operations described herein. In certain aspects, the computer program product may include packaging material.

Further, it should be appreciated that modules or other appropriate means for performing the methods and techniques described herein can be downloaded or otherwise obtained by a station or access point as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a station or access point can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. An apparatus for wireless communication, comprising:
a processing system configured to generate a physical layer convergence protocol data unit (PPDU) having an aggregated medium access control (MAC) protocol data unit (A-MPDU), the A-MPDU comprising a plurality of frames, each of the plurality of frames being addressed to a plurality of stations, wherein one or more parameters used for the generation of the A-MPDU or the PPDU depend on one or more capabilities of each of the plurality of stations; and
a first interface configured to output the PPDU for transmission.

2. The apparatus of claim 1, wherein the one or more parameters correspond to at least one of a minimum spacing between the plurality of frames of the A-MPDU, a maximum length of the A-MPDU, a maximum number of the plurality of frames of the A-MPDU, or a data rate of the A-MPDU.

3. The apparatus of claim 1, wherein the one or more capabilities comprises support for at least one of a modulation and coding scheme (MCS) for the PPDU, a spatial stream (SS) for the transmission, a bandwidth (BW) corresponding to the PPDU, a guard interval (GI) of the PPDU, a coding of the PPDU, a duration of the PPDU, or an amount of padding of the PPDU.

4. The apparatus of claim 1, further comprising a second interface configured to obtain an indication of the one or more capabilities of each of the plurality of stations.

5. The apparatus of claim 1, wherein the processing system is further configured to determine the one or more parameters based on one of the plurality of stations having a lowest capability with respect to the one or more parameters.

6. The apparatus of claim 1, wherein the plurality of frames comprise data frames, management frames, or both data and management frames.

7. The apparatus of claim 1, further comprising a second interface configured to:
obtain an indication of the one or more capabilities of each of the plurality of stations, wherein the processing system is further configured to identify a type of the plurality of frames based on the capabilities of the plurality of stations.

8. The apparatus of claim 7, wherein identifying the type of the plurality of frames comprises identifying whether the plurality of frames comprise data frames, management frames, or both data and management frames, based on the indication of the one or more capabilities of each of the plurality of stations.

9. The apparatus of claim 1, wherein the processing system is further configured to determine an operating mode of each of the plurality of stations, wherein the A-MPDU is generated based on the operating modes of the plurality of stations.

10. The apparatus of claim 9, wherein the processing system is further configured to:
determine a first value for the one or more parameters if the operating modes of the plurality of stations comprise a first operating mode; and
determine a second value for the one or more parameters if the operating mode of at least one of the plurality of stations comprise a second operating mode.

11. The apparatus of claim 10, further comprising a second interface configured to obtain a first indication of the one or more capabilities corresponding to the first operating mode and a second indication of the one or more capabilities corresponding to the second operating mode, the determination of the first value and the second value being based on the first indication and the second indication, respectively.

12. The apparatus of claim 10, wherein the first operating mode comprises an active mode, and wherein the second operating mode comprises a power save mode.

13. The apparatus of claim 10, wherein the first value of the one or more parameters comprises a first data rate, and wherein the second value of the one or more parameters comprises a second data rate.

14. The apparatus of claim 9, wherein the operating mode comprises a power management state of the station.

15. The apparatus of claim 14, wherein the A-MPDU is generated if the power management state of the plurality of stations comprises an active mode.

16. The apparatus of claim 1, wherein a data rate of the A-MPDU is a highest data rate supported by the plurality of stations.

17. The apparatus of claim 1, wherein the processing system is further configured to determine the one or more parameters based on a type of each of the plurality of stations.

18. The apparatus of claim 17, wherein the type of each of the plurality of stations comprises a high efficiency (HE) station or an extremely high throughput (EHT) station.

19. The apparatus of claim 1, further comprising at least one antenna, wherein the PPDU is output for transmission via the at least one antenna.

20. An apparatus for wireless communication, comprising:
a first interface configured to obtain a physical layer convergence protocol data unit (PPDU) having an aggregated medium access control (MAC) protocol data unit (A-MPDU), the A-MPDU comprising a plurality of frames, each of the plurality of frames being addressed to a plurality of stations, wherein the apparatus is associated with one of the plurality of stations, and wherein one or more parameters associated with the A-MPDU or the PPDU correspond to one or more capabilities of the apparatus; and
a processing system configured to decode the PPDU.

21. The apparatus of claim 20, further comprising a second interface configured to output an indication of the one or more capabilities of the apparatus.

22. The apparatus of claim 21, wherein the one or more parameters comprises at least one of a minimum spacing between the plurality of frames of the A-MPDU, a maximum length of the A-MPDU, or a maximum number of the plurality of frames of the A-MPDU, or a data rate of the A-MPDU.

23. The apparatus of claim 20, wherein the one or more capabilities comprises support for at least one of a modulation and coding scheme (MCS) for the PPDU, a spatial stream (SS) for transmission of the PPDU, a bandwidth (BW) corresponding to the PPDU, a guard interval (GI) of the PPDU, a coding of the PPDU, a duration of the PPDU, or an amount of padding of the PPDU.

24. The apparatus of claim 20, wherein the A-MPDU is obtained when a power management state of the apparatus comprises an active mode.

25. The apparatus of claim 20, further comprising a second interface configured to output for transmission a first indication of the one or more capabilities corresponding to a first operating mode of the apparatus and a second indication of the one or more capabilities corresponding to a second operating mode of the apparatus.

26. The apparatus of claim 25, wherein the first operating mode comprises an active mode, and wherein the second operating mode comprises a power save mode.

27. The apparatus of claim 20, wherein the plurality of frames comprise data frames, management frames, or both data and management frames.

28. The apparatus of claim 20, further comprising a second interface configured to output for transmission an indication of whether the apparatus supports aggregation of data frames, management frames, or both data and management frames, wherein a type of the plurality of frames is in accordance with the indication.

29. The apparatus of claim 20, further comprising at least one antenna, wherein the PPDU is obtained via the at least one antenna.

30. An apparatus for wireless communication, comprising:
at least one antenna;
a processing system configured to generate a physical layer convergence protocol data unit (PPDU) having an aggregated medium access control (MAC) protocol data unit (A-MPDU), the A-MPDU comprising a plurality of frames, each of the plurality of frames being addressed to a plurality of stations, wherein one or more parameters used for the generation of the A-MPDU or the PPDU depend on one or more capabilities of each of the plurality of stations; and
a first interface configured to output the PPDU for transmission via the at least one antenna.
